(19) United States
(12) Patent Application Publication
(10) Pub. No.: US 2026/0135053 A1
(43) Pub. Date: May 14, 2026

(54) RELAY

(71) Applicant: Xiamen Hongfa Electric Power Controls Co., Ltd., Xiamen, Fujian (CN)

(72) Inventors: Meng WANG, Xiamen, Fujian (CN); Songsheng CHEN, Xiamen, Fujian (CN); Wenguang DAI, Xiamen, Fujian (CN); Dapeng FU, Xiamen, Fujian (CN); Fengzhu XIE, Xiamen, Fujian (CN)

(73) Assignee: Xiamen Hongfa Electric Power Controls Co., Ltd., Xiamen, Fujian (CN)

(21) Appl. No.: 19/121,079

(22) PCT Filed: Oct. 8, 2023
(86) PCT No.: PCT/CN2023/123432

§ 371 Date: Apr. 14, 2025

(30) Foreign Application Priority Data
Oct. 12, 2022 (CN) 202222685510.X

(51) Int. Cl. H01H 50/42; H01H 50/04; H01H 50/44; H01H 50/58; H01H 50/64

(52) U.S. Cl. CPC H01H 50/42; H01H 50/04; H01H 50/58; H01H 50/642; H01H 2050/446

(57) ABSTRACT

Provided in the present disclosure is a relay. The relay comprises a contact assembly (2), a short-circuit resistant assembly (3) and a supporting component (6). The contact assembly (2) comprises a movable contact spring (22), and a pair of stationary contact lead-out ends (21) capable of coming into contact with or being separated from the movable contact spring (22); the short circuit resistant assembly (3) comprises an upper conductive magnet (31) and a lower conductive magnet (32); the supporting component (6) is used for bearing the upper conductive magnet (31); and the lower conductive magnet (32) is fixed at the bottom of the movable contact spring (22), and a magnetic conductive loop can be formed between the upper conductive magnet (31) and the lower conductive magnet (32), such that an attractive force is generated when a large fault current occurs in the movable contact spring (22), so as to resist an electrodynamic repulsion force between the movable contact spring (22) and the stationary contact lead-out ends (21). In the present disclosure, the upper conductive magnet (31) is of a fixed structure which is borne by the supporting component (6), such that the requirement of a holding force can be satisfied without needing a large-size coil, thereby being conducive to making the relay lightweight.

### CROSS-REFERENCE

The present disclosure claims priority to Chinese Patent Application No. 202222685510.X, filed on Oct. 12, 2022, the entire content of which is incorporated herein by reference in its entirety.

### TECHNICAL FIELD

The present disclosure relates to the technical field of power and electric appliances and, more particularly, to a relay.

### BACKGROUND

With an increasing requirement for endurance mileage of new energy vehicles, heat loss of a high-voltage DC relay needs to be small under normal circumstances. In case of a short circuit of a battery pack, the relay is required to withstand high short-circuit current and voltage due to a large battery capacity. When a short-circuit load is large, contacts of the high-voltage DC relay will pop open due to an electro-dynamic repulsion force generated by the short-circuit current, which in turn leads to an electric arc; and the high short-circuit current and voltage of the load may cause sudden and intense arcing of the contacts.

In the related art, a follower anti-short circuit ring electromagnetic structure is usually installed in a movable assembly. The lower magnetizer and the movable contact piece are fixed together, an electromagnetic attraction force generated by an upper magnetizer on a lower magnetizer in the anti-short circuit ring electromagnetic structure is used to ensure that the movable contact does not pop open when the short-circuit current generates the electro-dynamic repulsion force. Since the movable assembly is supported by a latching force of a movable iron core and the latching force is an electromagnetic force generated by a coil is energized, if the coil has a limited power, the latching force for supporting the anti-short circuit ring is also limited. Consequently, when the short-circuit current reaches a certain preset value, the lower magnetizer will also generate an electromagnetic attraction force on the upper magnetizer. When the latching force of the iron core cannot support the electromagnetic attraction force of the lower magnetizer on the upper magnetizer, the contact will still pop open.

To solve the problem, the related art increases the size of the coil to improve the latching force of the movable iron core. However, the larger size of the coil will increase an overall volume of the relay, which is not conducive to a lightweight requirement for the relay.

### SUMMARY

Embodiments of the present disclosure provides a relay that meets safety and lightweight requirements.

A relay according to embodiments of the present disclosure includes: a contact assembly including a movable contact piece and a pair of static contact leading-out terminals, the movable contact piece can come into contact with or separate from the pair of static contact leading-out terminals; an anti-short circuit assembly including an upper magnetizer and a lower magnetizer; and a support component fixedly disposed relative to the static contact leading-out terminals and configured to carry the upper magnetizer. The lower magnetizer is fixed at a bottom of the movable contact piece, and a magnetic circuit is formed between the upper magnetizer and the lower magnetizer to generate an attraction force when the movable contact piece undergoes a faulty high current, so as to resist an electro-dynamic repulsion force between the movable contact piece and the static contact leading-out terminals.

According to some embodiments of the present disclosure, the relay further includes an insulating member disposed between the support component and the upper magnetizer, the support component carrying the upper magnetizer through the insulating member.

According to some embodiments of the present disclosure, one of the upper magnetizer and the insulating member is provided with a positioning block, and the other thereof is provided with a positioning groove, the positioning block is at least partially disposed in the positioning groove.

According to some embodiments of the present disclosure, the support component, the insulating member, and the upper magnetizer are of an integrally formed structure.

According to some embodiments of the present disclosure, the insulating member is provided with a positioning hole at a side facing the support component, and the support component is at least partially disposed in the positioning hole.

According to some embodiments of the present disclosure, there are a plurality of insulating members distributed along a width direction of the movable contact piece, and the plurality of insulating members are disposed at both sides along a length direction of the upper magnetizer.

According to some embodiments of the present disclosure, there are a plurality of support components, and the plurality of support components are disposed between the pair of static contact leading-out terminals and distributed at both sides of the upper magnetizer.

According to some embodiments of the present disclosure, the relay further includes a contact container, wherein the contact container includes a yoke plate, and the support component is disposed on the yoke plate.

According to some embodiments of the present disclosure, the contact container further includes a ceramic cover disposed on the yoke plate, the static contact leading-out terminals at least partially extend into the ceramic cover, and the support component, the movable contact piece, and the anti-short circuit assembly are disposed inside the ceramic cover.

According to some embodiments of the present disclosure, a gap is provided between the upper magnetizer and a top inner wall of the ceramic cover, and the upper magnetizer is not in contact with the top inner wall of the ceramic cover.

According to some embodiments of the present disclosure, the support component is of a columnar structure.

According to some embodiments of the present disclosure, the relay further includes a drive assembly, wherein the drive assembly includes a push rod unit, and the push rod unit can drive the movable contact piece to move in a direction close to the static contact leading-out terminals. The movable contact piece and the lower magnetizer are movable members, and the movable members fit with the push rod unit through a limit protrusion and a limit hole.

According to some embodiments of the present disclosure, the movable members further include a support part fixedly connected to the lower magnetizer and disposed between the push rod unit and the lower magnetizer; the push rod unit fits with the support part through the limit protrusion and the limit hole; and the push rod unit is configured to drive the movable contact piece to move.

One embodiment of the present disclosure has at least the following advantages or beneficial effects.

For the relay according to embodiments of the present disclosure, when the movable contact piece contacts with static contacts at the bottom of the pair of static contact leading-out terminals, current may flow in from one static contact leading-out terminal, pass through the movable contact piece, and flow out from the other static contact leading-out terminal, thereby achieving load connection.

For the relay according to embodiments of the present disclosure, the lower magnetizer is disposed at the bottom of the movable contact piece, and may move together with the movable contact piece towards a direction close to the static contact leading-out terminals. The lower magnetizer may move in a direction close to the upper magnetizer, forming a magnetic circuit between the upper magnetizer and the lower magnetizer. In the event of a faulty high current in the movable contact piece, by disposing the upper magnetizer above the movable contact piece and the lower magnetizer below the movable contact piece, which is equivalent to the movable contact piece sandwiched between the upper magnetizer and the lower magnetizer, when the upper magnetizer generates an attraction force on the lower magnetizer, this attraction force plays a role in pulling the movable contact piece and is used to resist the electro-dynamic repulsion force caused by the faulty current between the movable contact piece and the static contact leading-out terminal, so as to avoid a situation where mutual disengagement between the movable contact piece and the static contact leading-out terminals leads to arcing and explosion, and ensure the reliability and safety of the contact between the movable contact piece and the static contact leading-out terminals.

For the relay according to embodiments of the present disclosure, the upper magnetizer is carried by the support component that is fixedly disposed relative to the static contact leading-out terminals, i.e., the upper magnetizer is fixed in a fixed position except for the drive assembly. In the anti-short circuit assembly, the upper magnetizer and the lower magnetizer form a magnetic circuit, and the electromagnetic attraction generated by this magnetic circuit acts on a stationary component, eliminating the risk that the movable iron core disengages and the relay burns or explodes under the action of strong electric arcs. The upper magnetizer adopts a fixed structure, and the support component plays a role in carrying the upper magnetizer, so that the drive assembly does not need to bear the attraction force of the lower magnetizer on the upper magnetizer during the short circuit, and the requirement for the latching force may be satisfied without need for a coil with a larger volume, thereby meeting the lightweight requirement for the relay.

### BRIEF DESCRIPTION OF THE DRAWINGS

The above and other features and advantages of the present disclosure will become more apparent by describing in detail exemplary embodiments with reference to the accompanying drawings.

FIG. 1 shows a structural schematic view of a relay according to a first embodiment of the present disclosure;

FIG. 2 shows a top view of the relay according to the first embodiment of the present disclosure;

FIG. 3 shows a sectional view along plane A-A in FIG. 2;

FIG. 4 shows an exploded view of the relay according to the first embodiment of the present disclosure;

FIG. 5 shows a schematic view of a working state of the relay according to the first embodiment of the present disclosure;

FIG. 6 shows a structural schematic view of a relay according to a second embodiment of the present disclosure;

FIG. 7 shows a top view of the relay according to the second embodiment of the present disclosure;

FIG. 8 shows a sectional view along plane B-B in FIG. 7;

FIG. 9 shows an exploded view of the relay according to the second embodiment of the present disclosure;

FIG. 10 shows a structural schematic view of a relay according to a third embodiment of the present disclosure;

FIG. 11 shows a sectional view of the relay according to the third embodiment of the present disclosure;

FIG. 12 shows an exploded view of the relay according to the third embodiment of the present disclosure.

### REFERENCE NUMERALS

1. contact container; 2. contact assembly; 3. anti-short circuit assembly; 4. drive assembly; 5. connector; 6. support component; 7. insulating member; 11. ceramic cover; 12. yoke plate; 21. static contact leading-out terminal; 22. movable contact piece; 31. upper magnetizer; 312. gap; 32. lower magnetizer; 41. push rod unit; 411. push rod; 412. mounting seat; 413. limit protrusion; 42. support part; 421. baffle; 422. limit hole; 43. elastic member; 44. electromagnetic unit; 441. coil bobbin; 442. coil; 443. movable iron core.

### DETAILED DESCRIPTION

Exemplary embodiments will be now described more fully with reference to the accompanying drawings. However, the exemplary embodiments may be embodied in a variety of forms and should not be construed as is limited to the embodiments set forth herein. Although relative terms such as “above” and “under” are used herein to describe the relationship of one component relative to another component, such terms are used herein only for the sake of convenience, for example, in the directions shown in the figures. It can be understood that if the referenced device is inversed upside down, a component described as “above” will become a component described as “under”. Other relative terms such as “top” and “bottom” also have similar meanings. When a structure is described as “above” another structure, it probably means that the structure is integrally formed on another structure, or the structure is “directly” disposed on another structure, or the structure is “indirectly” disposed on another structure through an additional structure.

Words “one”, “a/an”, “the” and “said” are used herein to indicate the presence of one or more elements/component parts/and others. Terms “including” and “having” have an inclusive meaning which means that there may be additional elements/component parts/and others in addition to the listed elements/component parts/and others. Terms such as “first” and “second” are used herein only as markers and do not limit the number of objects modified after them.

### First Embodiment

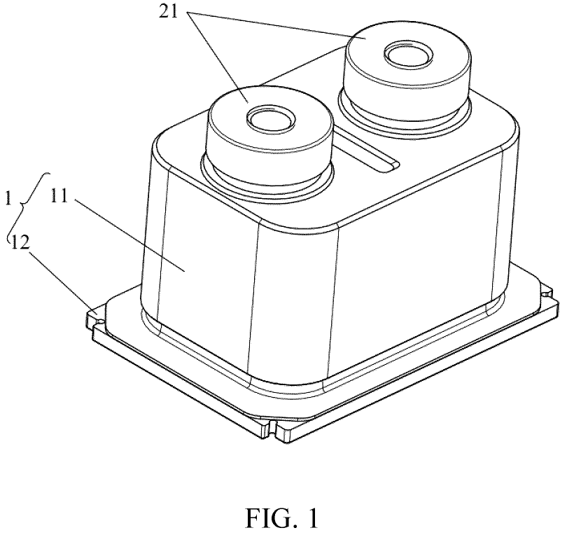

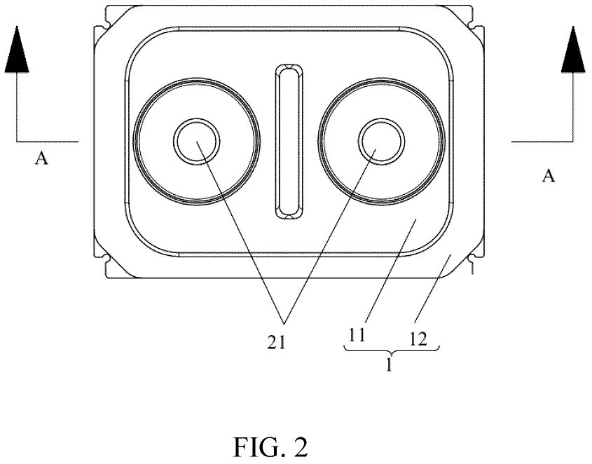

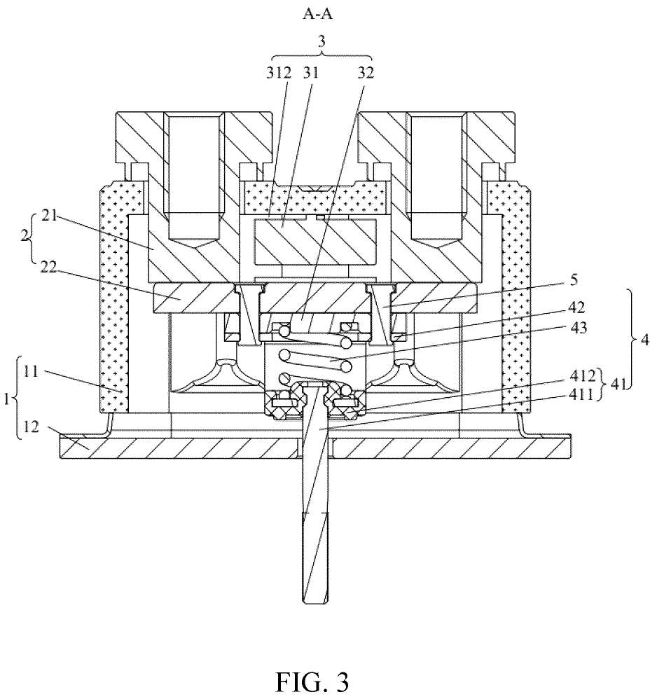

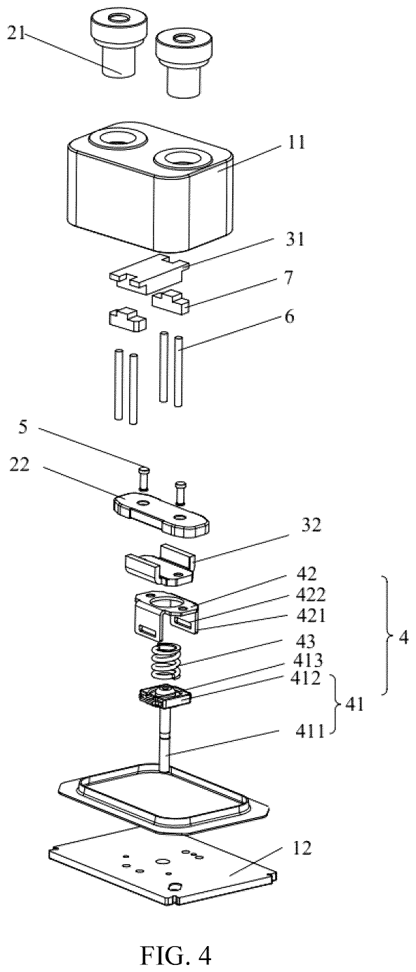

As shown in FIGS. 1-4, FIG. 1 shows a structural schematic view of a relay according to a first embodiment of the present disclosure; FIG. 2 shows a top view of the relay according to the first embodiment of the present disclosure; FIG. 3 shows a sectional view along A-A plane in FIG. 2; FIG. 4 shows an exploded view of the relay according to the first embodiment of the present disclosure.

This embodiment provides a relay including a contact assembly 2, and the contact assembly 2 includes a movable contact piece 22 and a pair of static contact leading-out terminals 21. The movable contact piece 22 is used to contact with or separate from the pair of static contact leading-out terminals 21. When the movable contact piece 22 comes into contact with static contacts at the bottom of the pair of static contact leading-out terminals 21, current flows in from one static contact leading-out terminal 21, passes through the movable contact piece 22, and flows out from the other static contact leading-out terminal 21, thereby achieving load connection.

When a short-circuit load is large, under the action of a short-circuit current, an electro-dynamic repulsion force will be generated between the movable contact piece 22 and the static contact leading-out terminals 21 and cause contacts to pop open, resulting in arcing and violent combustion of the contacts, and even possible explosion. Accordingly, as shown in FIGS. 1-4, the relay according to this embodiment also includes an anti-short circuit assembly 3. The anti-short circuit assembly 3 includes an upper magnetizer 31 and a lower magnetizer 32, and the lower magnetizer 32 is disposed at the bottom of the movable contact piece 22. A magnetic circuit is formed between the upper magnetizer 31 and the lower magnetizer 32 to generate an attraction force when the movable contact piece 22 experiences a faulty high current, so as to resist the electro-dynamic repulsion force between the movable contact piece 22 and the static contact leading-out terminals 21. The upper magnetizer 31 and the lower magnetizer 32 may be made of materials such as iron, cobalt, nickel, and alloys thereof.

The lower magnetizer 32 is fixed at the bottom of the movable contact piece 22, and may move together with the movable contact piece 22 towards a direction close to the static contact leading-out terminals 21. The lower magnetizer 32 may move in a direction close to the upper magnetizer 31, forming the magnetic circuit between the upper magnetizer 31 and the lower magnetizer 32. In the event of the faulty high current in the movable contact piece 22, by disposing the upper magnetizer 31 above the movable contact piece 22 and the lower magnetizer 32 below the movable contact piece 22, which is equivalent to the movable contact piece 22 is sandwiched between the upper magnetizer 31 and the lower magnetizer 32, when the upper magnetizer 31 generates an attraction force on the lower magnetizer 32, this attraction force plays a role in pulling the movable contact piece 22 and is used to resist the electro-dynamic repulsion force caused by the faulty current between the movable contact piece 22 and the static contact leading-out terminal 21, so as to avoid a situation where mutual disengagement between the movable contact piece 22 and the static contact leading-out terminals 21 leads to arcing and explosion, and ensure the reliability and safety of the contact between the movable contact piece 22 and the static contact leading-out terminals 21.

It should be noted that, as shown in FIGS. 3-4, the relay also includes a drive assembly 4 that includes a push rod unit 41. The push rod unit 41 may drive the movable contact piece 22 to move in the direction close to the static contact leading-out terminals 21. The push rod unit 41 is movably disposed and provides power for the movable contact piece 22, pushing the movable contact piece 22 to move, so as to achieve contact and separation between the movable contact piece 22 and the static contact leading-out terminals 21.

If both the upper magnetizer 31 and the lower magnetizer 32 are movably disposed, the upper magnetizer 31 and the lower magnetizer 32 need to be supported by a latching force of the drive assembly 4. If the latching force cannot support the attraction force of the lower magnetizer 32 on the upper magnetizer 31, there will be a situation where the upper magnetizer 31 and the lower magnetizer 32 fall, still causing the movable contact piece 22 to disengage from the static contact leading-out terminals 21. In the related art, a size of a coil of the drive assembly 4 is increased to achieve a purpose of increasing the latching force, but the coil with a larger volume can hardly meet a lightweight requirement.

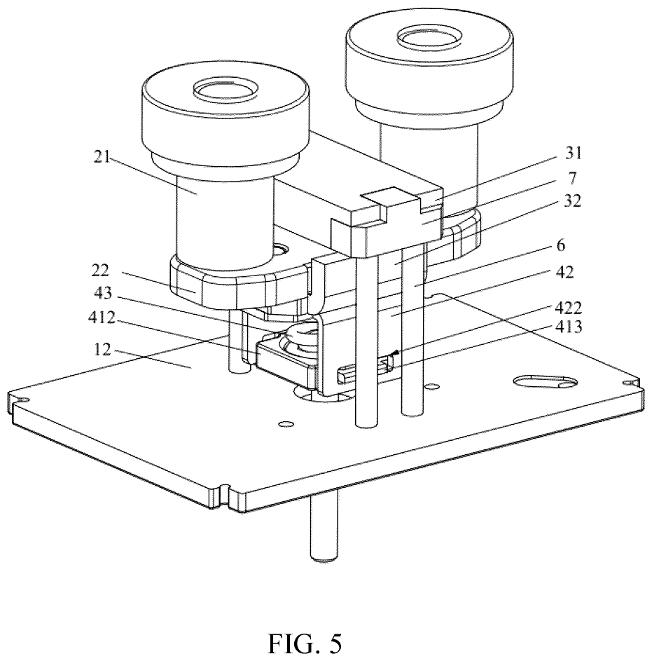

Accordingly, as shown in FIGS. 3-5, the relay according to this embodiment also includes a support component 6 used to carry the upper magnetizer 31.

The upper magnetizer 31 is carried by the support component 6 that is fixedly disposed relative to the static contact leading-out terminals 21, i.e., the upper magnetizer 31 is fixed in a fixed position other than the drive assembly 4. In the anti-short circuit assembly 3, the upper magnetizer 31 and the lower magnetizer 32 form the magnetic circuit, and the electromagnetic attraction generated by this magnetic circuit is transferred from a movable assembly (such as the drive assembly 4) to a stationary component (which is fixed and still), eliminating the risk that a movable iron core 443 disengages and the relay burns or explodes under the action of strong electric arcs. At this time, the upper magnetizer 31 adopts a fixed structure, and the support component 6 plays a role in carrying the upper magnetizer 31, so that the drive assembly 4 does not need to bear the attraction force of the lower magnetizer 32 on the upper magnetizer 31 during the short circuit, and the requirement for the latching force may be satisfied without need for a coil 442 with a larger volume, thereby meeting a lightweight requirement for the relay.

In an embodiment, the support component 6 is of a columnar structure that occupies a small space and has good support and load-bearing strength.

In this embodiment, as shown in FIGS. 3-5, the relay further includes an insulating member 7 disposed between the support component 6 and the upper magnetizer 31. The support component 6 carries the upper magnetizer 31 through the insulating member 7.

If the support component 6 is made of a metal material, it may ensure that the support component 6 has good structural strength. However, when the bottom of the support component 6 is fixed to the stationary component (such as a metal plate), an insulating effect of the upper magnetizer 31 cannot be guaranteed. By providing the insulating member 7 between the support component 6 and the upper magnetizer 31, the insulating member 7 serves to isolate the support component 6 from the upper magnetizer 31, ensuring the insulating effect of the upper magnetizer 31. The support component 6 supports the insulating member 7, and the insulating member 7 supports the upper magnetizer 31, so that the support component 6 carries the upper magnetizer 31 through the insulating member 7, and the insulating member 7 serves as an intermediate support. The insulating member 7 may specifically be an insulating block, and a contact area between the insulating block and the upper magnetizer 31 is relatively large, which improves a support effect on the upper magnetizer 31.

It can be understood that the insulating member 7 is specifically made of an insulating material, such as plastic.

It can be understood that if the insulating member 7 is disposed between the support component 6 and the upper magnetizer 31, the support component 6 may be made of a metal or insulating material, and the material of the support component 6 is not limited. However, if there is no insulating member 7 between the support component 6 and the upper magnetizer 31, in order to avoid a short circuit risk of the upper magnetizer 31, the support component 6 needs to be made of an insulating material.

In this embodiment, as shown in FIGS. 3-5, one of the upper magnetizer 31 and the insulating member 7 is provided with a positioning block, and the other thereof is provided with a positioning groove, the positioning block is at least partially located in the positioning groove. By fitting between the positioning block and the positioning groove, a positioning effect between the upper magnetizer 31 and the insulating member 7 is ensured.

Specifically, the insulating member 7 is provided with a positioning block protruding in a direction towards the upper magnetizer 31, and the upper magnetizer 31 is provided with a positioning groove corresponding to the positioning block. The positioning block is inserted into the positioning groove, which is equivalent to embedding the positioning block into the positioning groove, so as to ensure the accuracy of the relative position between the insulating member 7 and the upper magnetizer 31.

In addition, there is an accommodation groove on a side of the upper magnetizer 31 facing the insulating member 7, and the accommodation groove is used to accommodate the insulating member 7. The accommodation groove provides a space for accommodating the insulating member 7, and a side wall of the accommodation groove plays a role in limiting the position of the insulating member 7. The upper magnetizer 31 is at least partially embedded in the accommodation groove, making the overall appearance of the upper magnetizer 31 and the insulating member 7 similar to a rectangular prism structure, which is neatly structured and aesthetically pleasing.

In this embodiment, the support component 6, the insulating member 7, and the upper magnetizer 31 are integrally formed structures. Since the support component 6, insulating member 7, and upper magnetizer 31 are of an integrally formed structure, the production and assembly of individual parts may be saved, effectively reducing production costs.

In this embodiment, a positioning hole is provided on a side of the insulating member 7 facing the support component 6, and the support component 6 at least partially passes through the positioning hole.

If a top end surface of the support component 6 directly contacts a bottom surface of the insulating member 7, there may be a relative positional offset between the insulating member 7 and the support component 6 during actual use. By the support component 6 at least partially passing through the positioning hole of the insulating member 7, a pre-positioning effect between the support component 6 and the insulating member 7 may be achieved.

In this embodiment, there are a plurality of support components 6 disposed between the pair of static contact leading-out terminals 21 and distributed at both sides of the upper magnetizer 31.

By providing the plurality of support components 6 distributed at both sides of the upper magnetizer 31, the balance of support for the upper magnetizer 31 is ensured, avoiding any deviation of the upper magnetizer 31. By providing the plurality of support components 6 between the pair of static contact leading-out terminals 21, the insulating member 7 is also located between the pair of static contact leading-out terminals 21, so that the insulating member 7 is less affected by the electric arcs and does not occupy arc extinguishing space.

It should be noted that the number of support components 6 in this embodiment is specifically four, and four support components 6 are disposed at four corners of the upper magnetizer 31 to ensure the support effect on the upper magnetizer 31. The specific quantity of support components 6 is not limited in this disclosure and may be adjusted according to actual production situations.

In this embodiment, there are a plurality of insulating members 7 distributed along a width direction of the movable contact piece 22, and the plurality of insulating members 7 are disposed at both sides of a length direction of the upper magnetizer 31.

Since the plurality of insulating members 7 are disposed at both sides of the upper magnetizer 31, it is possible to ensure the balance of support for the upper magnetizer 31 and avoid any offset of the upper magnetizer 31. Since both ends of the movable contact piece 22 along its length direction may be in contact with the static contact leading-out terminals 21, the plurality of insulating members 7 distributed along the width direction of the movable contact piece 22 can avoid contact positions between the movable contact piece 22 and the static contact leading-out terminals 21.

It should be noted that the number of insulating members 7 in this embodiment is two, and two insulating member 7 are respectively disposed at both sides of the upper magnetizer 31. Each insulating member 7 corresponds to two support components 6. That is, each side of the upper magnetizer 31 is carried by the two support components 6 through one insulating member 7, and the support components 6 and insulating member 7 play the role of supporting the frame, ensuring the support effect on the upper magnetizer 31. The specific quantity of insulating members 7 is not limited to this embodiment and may be adjusted according to actual production situations.

In this embodiment, as shown in FIGS. 3-5, the relay further includes a contact container 1 that includes a yoke plate 12. The support component 6 is disposed on the yoke plate 12, i.e., the yoke plate 12 provides a fixation position for the support component 6. That is, a bottom of the support component 6 is fixed to the yoke plate 12, and a top of the support component 6 carries the upper magnetizer 31 through the insulating member 7, to ensure the support effect on the upper magnetizer 31.

It can be understood that the upper magnetizer 31 and the yoke plate 12 are connected through the support component 6 or through the support component 6 and the insulating member 7, so as to insulate the upper magnetizer 31 from the yoke plate 12, thereby improving the safety of the load.

In this embodiment, the contact container 1 further includes a ceramic cover 11 disposed on the yoke plate 12. The static contact leading-out terminal 21 at least partially extends into the ceramic cover 11, and the support component 6, the movable contact piece 22, and the anti-short circuit assembly 3 are disposed inside the ceramic cover 11.

The static contact leading-out terminal 21 is disposed on the ceramic cover 11, and the ceramic cover 11 provides a fixation position for the static contact leading-out terminal 21. The support component 6, the movable contact piece 22, and the anti-short circuit assembly 3 are disposed inside the ceramic cover 11, and the static contact leading-out terminal 21 at least partially extends into the ceramic cover 11. The ceramic cover 11 provides an insulating environment for the support component 6, the anti-short circuit assembly 3, the movable contact piece 22 of the contact assembly 2, and at least part of the static contact leading-out terminal 21.

If the upper magnetizer 31 is in direct contact with a top inner wall of the ceramic cover 11, a distance between the upper magnetizer 31 and the static contact leading-out terminal 21 is relatively close, making it difficult to meet the requirements of voltage resistance and safety distance. Thus, as shown in FIG. 3, in this embodiment, a gap 312 is provided between the upper magnetizer 31 and the top inner wall of the ceramic cover 11, so that the upper magnetizer 31 is not in direct contact with the top inner wall of the ceramic cover 11.

By providing the gap 312 between the upper magnetizer 31 and the top inner wall of the ceramic cover 11, the upper magnetizer 31 overall is not in contact with the top interior of the ceramic cover 11. The gap 312 between the upper magnetizer 31 and the top inner wall of the ceramic cover 11 increases a creepage distance between the two static contact leading-out terminals 21 in order to ensure the insulating creepage distance requirement.

It should be noted that the movable contact piece 22 may be in the shape of a straight piece, and along a length direction of the movable contact piece 22, under the action of the drive assembly 4, the two ends of the movable contact piece 22 may respectively contact the two static contact leading-out terminals 21, thereby achieving load connection. Bottoms of the static contact leading-out terminals 21 serve as static contacts, while the two ends of the movable contact piece 22 along its length direction may serve as movable contacts. The movable contacts at both ends of the movable contact piece 22 may protrude from other portions of the movable contact piece 22 or be flush with other portions.

It can be understood that the static contact may be integrally or separately disposed at the bottom of the static contact leading-out terminal 21, and the movable contact may be integrally or separately disposed at each end of the movable contact piece 22 along its length direction.

Two static contact leading-out terminals 21 are disposed on the ceramic cover 11, for example, at the top of the ceramic cover 11. Moreover, one end of each static contact leading-out terminal 21 extends into a contact chamber of the ceramic cover 11, and the other end thereof protrudes beyond an outer surface of the ceramic cover 11. The end of the static contact leading-out terminal 21 extending into the contact chamber is used to contact the movable contact piece 22.

In this embodiment, as shown in FIGS. 3-5, the upper magnetizer 31 has a linear structure and extends along the width direction of the movable contact piece 22; and/or the lower magnetizer 32 has a U-shaped structure, with its opening facing the movable contact piece 22, and portions of the lower magnetizer 32 located at both sides of the width direction of the movable contact piece 22 may be in contact with the upper magnetizer 31.

The upper magnetizer 31 has a linear structure, and is correspondingly disposed at a position between the two movable contacts of the movable contact piece 22, i.e., located right above the push rod unit 41. The upper magnetizer 31 extends along the width direction of the movable contact piece 22, so that the upper magnetizer 31 matches and corresponds to the lower magnetizer 32.

The lower magnetizer 32 has a U-shaped structure with an opening facing the movable contact piece 22, so that two side arms of the lower magnetizer 32 extend in the direction towards the upper magnetizer 31, and hence the two side arms of the upper magnetizer 31may respectively approach or contact two ends of the upper magnetizer 31, forming a surrounding magnetically conductive ring on the movable contact piece 22 along its width direction. Since the two ends of the movable contact piece 22 along its length direction are movable contacts, the surrounding magnetically conductive ring formed along the width direction of the movable contact piece 22 will not interfere. When the movable contact piece 22 experiences a faulty high current, an electromagnetic attraction force in a pressure direction of the movable contact is generated to resist the electro-dynamic repulsion force generated by the faulty current between the movable contact piece 22 and the static contact leading-out terminal 21.

It should be noted that the relay according to the embodiment of the present disclosure may include a housing, in which the contact container 1, the contact assembly 2, the anti-short circuit assembly 3, and the drive assembly 4 are disposed, and the housing functions to accommodate and protect. The relay according to the embodiment of the present disclosure may not include any housing, but rather these components may be assembled and directly mounted in an application product, such as a battery pack and an electrical control box.

It should be noted that the housing has a hollow chamber in communication with an exterior of the housing. The contact container 1 is disposed in the hollow chamber, and since the contact container 1 includes the ceramic cover 11 and the yoke plate 12, the ceramic cover 11 and the yoke plate 12 enclose the contact chamber.

In an embodiment, the movable contact piece 22 and the lower magnetizer 32 form a movable member, and the movable member fits with the push rod unit 41 through a limit protrusion 413 and a limit hole 422. Under the action of the fit between the limit protrusion 413 and the limit hole 422, a moving force of the push rod unit 41 may be transmitted to the movable member, facilitating contact or separation of the movable contact piece 22 with or from the pair of static contact leading-out terminals 21.

It should be noted that the limit hole 422 may be a through hole or a blind hole.

In this embodiment, as shown in FIGS. 3-5, the movable member further includes a support part 42 fixedly connected to the lower magnetizer 32 and disposed between the push rod unit 41 and the lower magnetizer 32. The push rod unit 41 is fitted with the support part 42 through the limit protrusion 413 and the limit hole 422, to drive the movable contact piece 22 to move.

By disposing the support part 42 between the push rod unit 41 and the lower magnetizer 32, the support part 42 serves as an intermediate connection between the push rod 411 assembly and the lower magnetizer 32. By fixedly connecting the support part 42 to the lower magnetizer 32, the support part 42 plays a role in carrying the lower magnetizer 32, ensuring a support effect on the lower magnetizer 32. Under the action of the fit between the limit protrusion 413 and the limit hole 422, the moving force of the push rod unit 41 may be transmitted to the support part 42, which is used to drive the movable contact piece 22 to move, facilitating the contact or separation of the movable contact piece 22 with or from the pair of static contact leading-out terminals 21.

It should be noted that the movable contact piece 22 is provided with a first connection hole; the lower magnetizer 32 is provided with a second connection hole corresponding to the first connection hole; and the support part 42 is provided with a third connection hole corresponding to the second connection hole. A connector 5 may be a bolt, a rivet, or a connection pin, and passes through the first connection hole, the second connection hole, and the third connection hole to ensure the stability of connection among the movable contact piece 22, the lower magnetizer 32, and the support part 42.

In this embodiment, as shown in FIGS. 3-5, the drive assembly 4 further includes an elastic member 43 disposed between the support part 42 and the push rod unit 41. One end of the elastic member 43 abuts against the push rod unit 41, and the other end thereof abuts against the movable member. Specifically, the other end of the elastic member 43 abuts against the support part 42, or the other end of the elastic member 43 passes through the support part 42 and abuts against the lower magnetizer 32.

The elastic member 43 is specifically a spring or other member having elasticity and a resetting function. If one end of the elastic member 43 abuts against the push rod unit 41 and the other end thereof abuts against the movable member, the push rod unit 41 will push the lower magnetizer 32 to move towards the upper magnetizer 31 through the support part 42 and the elastic member 43. If one end of the elastic member 43 abuts against the push rod unit 41, and the other end thereof passes through a through hole in the middle of the support part 42 and abuts against the lower magnetizer 32, a mounting groove is provided at the bottom of the lower magnetizer 32, so that the other end of the elastic member 43 passes through the through hole and is fixed in the mounting groove, and the push rod unit 41 may push the lower magnetizer 32 to move towards the upper magnetizer 31 through the elastic member 43.

In this embodiment, as shown in FIGS. 3-5, the push rod unit 41 includes a push rod 411 and a mounting seat 412. A top of the push rod 411 is fixed to the mounting seat 412, and the push rod 411 provides power for movement relative to the ceramic cover 11. The mounting seat 412 is used to mount a spring. Specifically, a positioning column and a positioning ring groove are provided in a center of the mounting seat 412. The positioning ring groove is disposed around the positioning column, and the positioning column passes through the bottom of the elastic member 43 to achieve positioning of the bottom of the elastic member 43 in its radial direction. The positioning ring groove is used to accommodate the elastic member 43 and achieve the positioning of the bottom of the elastic member 43 in its radial direction. At the same time, the mounting groove is provided at the bottom of the lower magnetizer 32 to achieve positioning of the top of the elastic member 43 along its radial direction, thereby ensuring a good positioning effect at both ends of the elastic member 43 in its axial direction and avoiding offset.

It should be noted that the push rod 411 and the mounting seat 412 are integrally formed using an integral injection molding process, which may reduce the assembly of parts and lower production costs.

In this embodiment, as shown in FIGS. 3-5, the support part 42 is a U-shaped bracket, and an open end of the U-shaped bracket is oriented towards the push rod unit 41. In this way, the U-shaped bracket acts as a protective cover for the elastic member 43 and provides protection for the elastic member 43.

In this embodiment, two side arms of the U-shaped bracket are used to limit the position of the elastic member 43. The side arms of the U-shaped bracket are fitted with the push rod unit 41 through the limit protrusion 413 and the limit hole 422.

Specifically, the two side arms of the U-shaped bracket serve to limit the position of the elastic member 43, avoiding disengagement of the elastic member 43 during compression and reset processes. The side arms of the U-shaped bracket are fitted with the push rod unit 41 through the limit protrusion 413 and the limit hole 422, and the push rod unit 41 may pull the lower magnetizer 32 to move by mean of the U-shaped bracket. At the same time, the two side arms of the U-shaped bracket extend along a movement direction of the push rod unit 41, i.e., the two side arms of the U-shaped bracket have a certain height, so that the U-shaped bracket is not in contact with the mounting seat 412, and there is a certain height space between the U-shaped bracket and the mounting seat 412, providing a movement space for the compression or reset of the elastic member 43.

It can be understood that one of the side arms of the U-shaped bracket and the push rod unit 41 is provided with the limit protrusion 413, and the other thereof is provided with the limit hole 422, which is used to limit the position of the limit protrusion 413.

Specifically, the limit protrusion 413 is provided on and protrudes from an outer wall of the mounting seat 412 of the push rod unit 41, and the limit hole 422 is provided on each of the two side arms of the support part 42. The limit protrusion 413 is at least partially disposed in the limit hole 422, and the limit hole 422 plays a role in limiting the limit protrusion 413 in an up-down direction.

In this embodiment, a gap is provided between the limit hole 422 and the limit protrusion 413 along the movement direction of the push rod unit 41.

By providing the gap between the limit hole 422 and the limit protrusion 413 and along the movement direction of the push rod unit 41, the gap provides the movement space for the limit protrusion 413, ensuring that the support part 42 may move up and down while also achieving a function of stopping the support part 42.

As shown in FIGS. 3-5, a working process of the relay according to this embodiment is as follows.

During initial installation, the elastic member 43 is in a pre-compressed state, and the support part 42, the lower magnetizer 32, and the movable contact piece 22 are fixed together. Under a driving action of the push rod unit 41, the support part 42, the lower magnetizer 32, and the movable contact piece 22 move synchronously. At this time, the limit protrusion 413 is in contact with a lower hole wall of the limit hole 422, to limit the position of the U-shaped bracket.

When the push rod unit 41 moves to an appropriate position, the movable contacts at both ends of the movable contact piece 22 are in contact with the two static contact leading-out terminals 21, respectively.

Subsequently, the push rod unit 41 continues to move upwards. As the movable contact piece 22 has already been in contact with bottom ends of the two static contact leading-out terminals 21, the movable contact piece 22 cannot continue to move upwards, but the push rod unit 41 continues to move upwards to achieve over-travel of the contacts. At this time, due to the fit between the limit protrusion 413 and an upper hole wall of the limit hole 422, the limit protrusion 413 provides a movement space for over-travel within a distance between the lower hole wall and the upper hole wall of the limit hole 422, allowing the push rod unit 41 to continue to press the elastic member 43. The elastic member 43 further provides upward support for the lower magnetizer 32, ensuring contact pressure and further avoiding disengagement of the movable contact piece 22 from the static contact leading-out terminals 21, so as to guarantee reliability of mutual contact between the movable contact piece 22 and the static contact leading-out terminals 21.

### Second Embodiment

This embodiment is similar to the first embodiment, and only differs in structures of the support part 42 and the mounting seat 412. It should be noted that in this embodiment, the limit protrusion 413 is initially in contact with the upper hole wall of the limit hole 422.

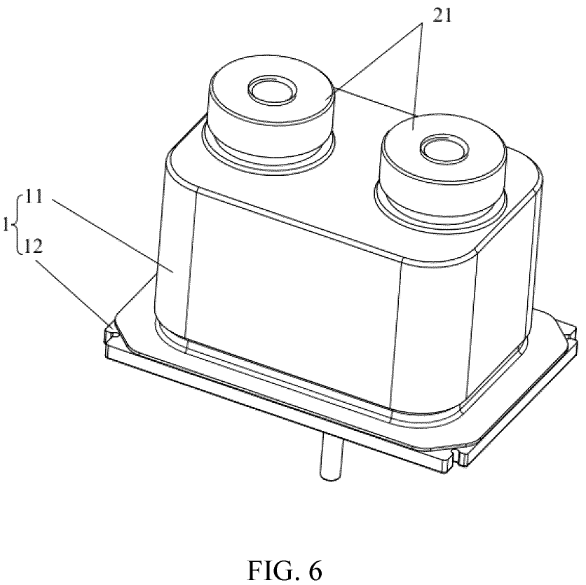

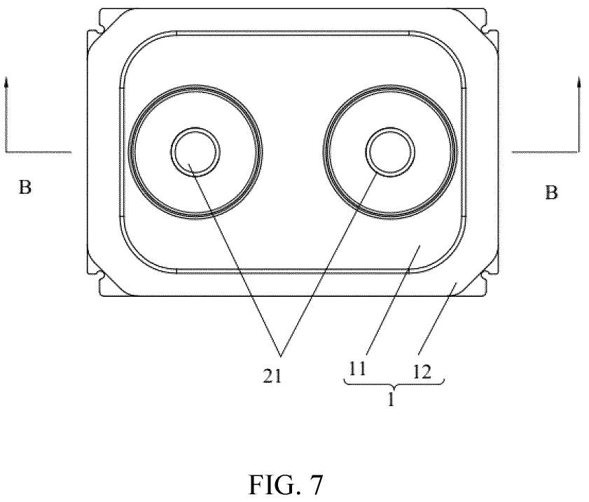

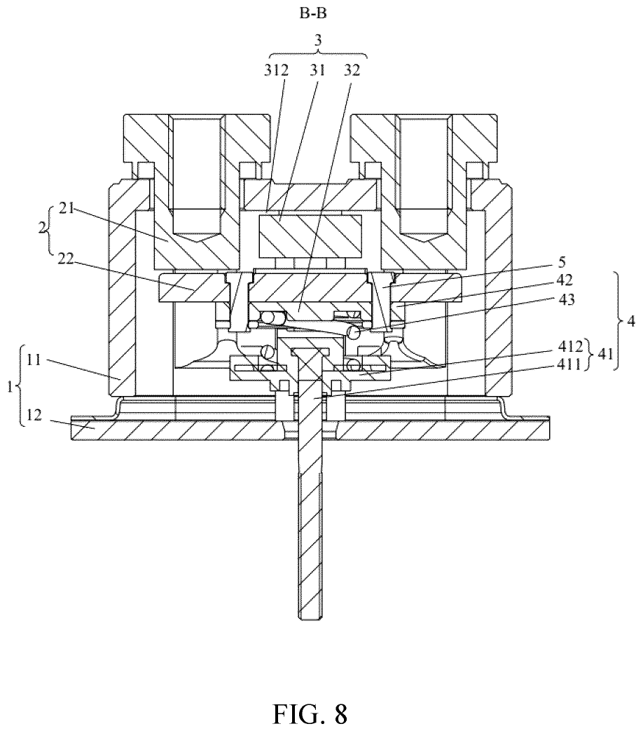

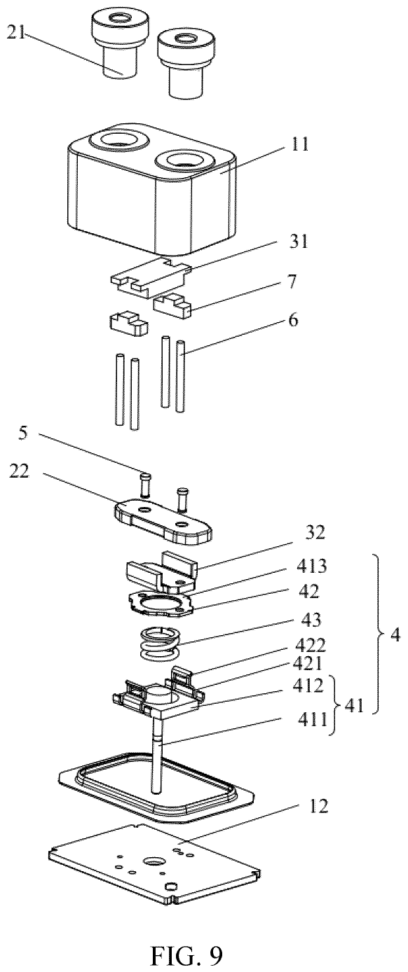

As shown in FIGS. 6-9, FIG. 6 shows a structural schematic view of a relay according to a second embodiment of the present disclosure; FIG. 7 shows a top view of the relay according to the second embodiment of the present disclosure; FIG. 8 shows a sectional view along B-B plane in FIG. 7; FIG. 9 shows an exploded view of the relay according to the second embodiment of the present disclosure.

The support part 42 in this embodiment is a fixed piece having a planar structure. A center of the fixed piece is provided with a through hole, which provides a clearance space for the elastic member 43. An upper end of the elastic member 43 passes through the through hole and abuts against the mounting groove of the lower magnetizer 32. The fixed piece has two protruding portions opposite to each other, and a third connection hole is provided in each protruding portion. The connector 5 passes through the first connection hole, the second connection hole, and the third connection hole to achieve fixation among the movable contact piece 22, the lower magnetizer 32, and the fixed piece.

In this embodiment, as shown in FIGS. 8-9, the push rod unit 41 has a baffle 421 facing the support part 42, and the baffle 421 is connected to the support part 42 and used to limit the elastic member 43.

The support part 42 is a fixed piece, and a planar structure of the fixed piece results in a relatively low height. Since the push rod unit 41 is provided with the baffle 421 facing the support part 42, that is, the mounting seat 412 of the push rod unit 41 is provided with the baffle 421, the baffle 421 plays a role in limiting the elastic member 43 and avoids disengagement of the elastic member 43 during compression and reset processes. Since the baffle 421 is connected to the fixed piece, the push rod unit 41 may drive the fixed piece and the lower magnetizer 32 to move synchronously. At the same time, the baffle 421 extends along the movement direction of the push rod unit 41, that is, the baffle 421 has a certain height, so that there is a certain height space between the fixed piece and the mounting seat 412, providing a movement space for the compression or reset of the elastic member 43.

In this embodiment, one of the support part 42 and the push rod unit 41 is provided with the limit protrusion 413, and the other thereof is provided with the limit hole 422, which is used to limit the position of the limit protrusion 413.

Specifically, the fixed piece is provided with a limit protrusion 413, and the baffle 421 of the mounting seat 412 in the push rod unit 41 is provided with a limit hole 422 or a limit slot. The limit protrusion 413 is at least partially disposed in the limit hole 422 or the limit slot. Two side walls of the limit hole 422 or two side walls of the limit slot along the movement direction are used to limit the limit protrusion 413.

It should be noted that there are two limit protrusions 413 disposed opposite to each other, and two protruding portions are disposed opposite to each other. The two limit protrusions 413 and the two protruding portions are spaced apart from each other, and an angle between the limit protrusion 413 and the protruding portion adjacent thereto is 90°.

### Third Embodiment

This embodiment is similar to the first embodiment, and only differs in lack of the support part 42, and the push rod unit 41 may still push or pull the movable member under a fit action of the limit protrusion 413 and the limit hole 422.

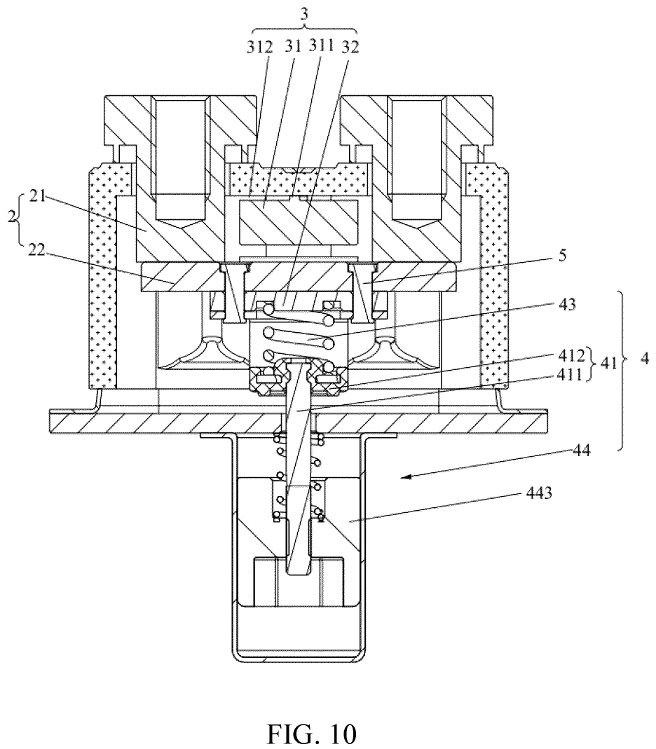

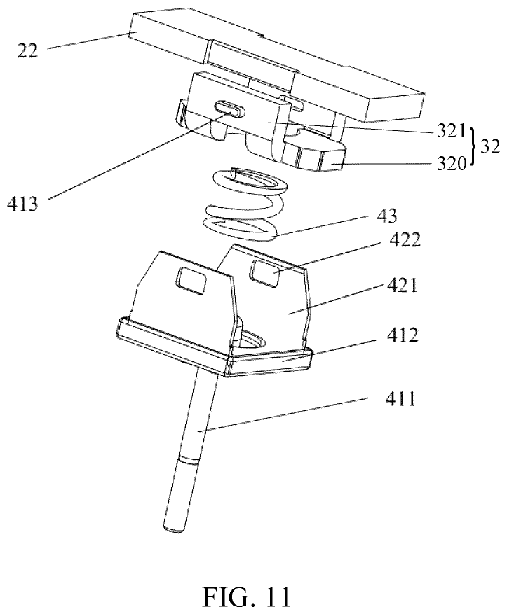

As shown in FIGS. 10-11, the lower magnetizer 32 in this embodiment includes a magnet body 320 and two side plates 321. The two side plates 321 are respectively disposed at both sides of the magnet body 320. The push rod unit 41 has two baffles 421 facing the lower magnetizer 32. The baffle 421 is fitted with the side plate 321 correspondingly through the limit protrusion 413 and the limit hole 422.

Since the push rod unit 41 is provided with the baffle 421 facing the lower magnetizer 32, that is, the mounting seat 412 of the push rod unit 41 is provided with the baffle 421, the baffle 421 plays a role in limiting the elastic member 43 and avoids disengagement of the elastic member 43 during compression and reset processes. Since the baffle 421 is connected to the side plate, the push rod unit 41 may drive the lower magnetizer 32 to move synchronously. At the same time, the baffle 421 extends along the movement direction of the push rod unit 41, that is, the baffle 421 has a certain height, so that there is a certain height space between the side plate 321 and the mounting seat 412, providing a movement space for the compression or reset of the elastic member 43.

It can be understood that the push rod unit 41 directly fits with the movable member, which is simpler to assemble and avoids interference between the movable contact piece 22 and the upper magnetizer 31 during over-travel.

It can be understood that one of the baffle 421 and the side plate 321 is provided with the limit protrusion 413, and the other thereof is provided with the limit hole 422, which is used to limit the position of the limit protrusion 413.

Specifically, the side plate 321 is provided with the limit protrusion 413, and the baffle 421 of the mounting seat 412 in the push rod unit 41 is provided with the limit hole 422. The limit protrusion 413 is at least partially disposed in the limit hole 422, and the limit hole 422 is used to limit the position of the limit protrusion 413.

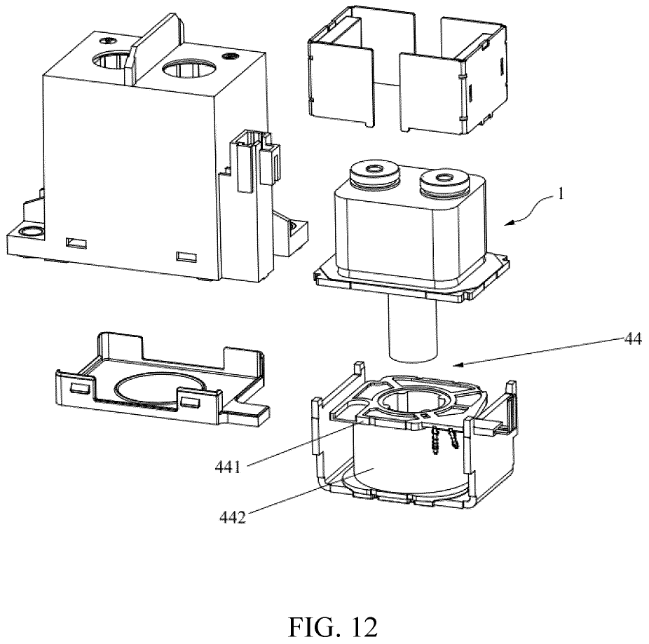

As shown in FIGS. 10-12, the drive assembly 4 further includes an electromagnetic unit 44, and the electromagnetic unit 44 includes a coil bobbin 441, a coil 442, a static iron core, and a movable iron core 443. The coil bobbin 441 is in the shape of a hollow cylinder and is made of an insulating material. The coil 442 is wound around the coil bobbin 441. The static iron core is fixedly disposed in a center hole of the coil bobbin 441 and is disposed opposite to the movable iron core 443. The movable iron core 443 is movably disposed in the center hole of the coil bobbin 441. The movable iron core 443 is connected to a bottom end of the push rod unit 41. When the coil 442 is energized, the movable iron core 443 is attracted by the static iron core 443 to move upwards, driving the push rod unit 41 to move upwards. When the coil 442 is de-energized, the movable iron core 443 moves downwards under the action of a reset spring, and the movable iron core 443 drives the push rod unit 41 to move downwards. The movable iron core 443 and the push rod unit 41 may be connected by screw thread connection, riveting, welding or other methods.

It should be understood that the application of the present disclosure is not limit to the detailed structure and arrangement of components provided in this specification. The present disclosure may have other embodiments, and may be implemented and carried out in various ways. The aforementioned variations and modifications fall within the scope of the present disclosure. It should be understood that the present disclosure revealed and defined in this specification may extend to all alternative combinations of two or more individual features that are apparent or mentioned in the text and/or drawings. All of the different combinations form various alternative aspects of the present disclosure. Embodiments described in this specification illustrate the best modes known for carrying out the present disclosure, and will allow those skilled in the art to utilize the present disclosure.

What is claimed is:

1. A relay, comprising:
a contact assembly (2) comprising a movable contact piece (22) and a pair of static contact leading-out terminals (21), the movable contact piece (22) can come into contact with or separate from the pair of static contact leading-out terminals (21);
an anti-short circuit assembly (3) comprising an upper magnetizer (31) and a lower magnetizer (32); and
a support component (6) fixedly disposed relative to the static contact leading-out terminals (21) and configured to carry the upper magnetizer (31),
wherein the lower magnetizer (32) is fixed at a bottom of the movable contact piece (22), and a magnetic circuit is formed between the upper magnetizer (31) and the lower magnetizer (32) to generate an attraction force when the movable contact piece (22) undergoes a faulty high current, so as to resist an electro-dynamic repulsion force between the movable contact piece (22) and the static contact leading-out terminals (21).

2. The relay according to claim 1, further comprising an insulating member (7) disposed between the support component (6) and the upper magnetizer (31), the support component (6) carrying the upper magnetizer (31) through the insulating member (7).

3. The relay according to claim 2, wherein one of the upper magnetizer (31) and the insulating member (7) is provided with a positioning block, and another one of the upper magnetizer (31) and the insulating member (7) is provided with a positioning groove, the positioning block is at least partially disposed in the positioning groove.

4. The relay according to claim 2, wherein the support component (6), the insulating member (7), and the upper magnetizer (31) are of an integrally formed structure.

5. The relay according to claim 2, wherein the insulating member (7) is provided with a positioning hole at a side facing the support component (6), and the support component (6) is at least partially disposed in the positioning hole.

6. The relay according to claim 2, wherein there are a plurality of insulating members (7) distributed along a width direction of the movable contact piece (22), and the plurality of insulating members (7) are disposed at both sides along a length direction of the upper magnetizer (31).

7. The relay according to claim 2, wherein there are a plurality of support components (6), and the plurality of support components (6) are disposed between the pair of static contact leading-out terminals (21) and distributed at both sides of the upper magnetizer (31).

8. The relay according to claim 1, further comprising a contact container (1), wherein the contact container (1) comprises a yoke plate (12), and the support component (6) is disposed on the yoke plate (12).

9. The relay according to claim 8, wherein the contact container (1) further comprises a ceramic cover (11) disposed on the yoke plate (12), the static contact leading-out terminals (21) at least partially extend into the ceramic cover (11), and the support component (6), the movable contact piece (22), and the anti-short circuit assembly (3) are disposed inside the ceramic cover (11).

10. The relay according to claim 9, wherein a gap (312) is provided between the upper magnetizer (31) and a top inner wall of the ceramic cover (11), and the upper magnetizer (31) is not in contact with the top inner wall of the ceramic cover (11).

11. The relay according to claim 1, wherein the support component (6) is of a columnar structure.

12. The relay according to any one of claims 1-11, further comprising a drive assembly (4), wherein the drive assembly (4) comprises a push rod unit (41), and the push rod unit (41) can drive the movable contact piece (22) to move in a direction close to the static contact leading-out terminals (21);
wherein the movable contact piece (22) and the lower magnetizer (32) are movable members, and the movable members fit with the push rod unit (41) through a limit protrusion (413) and a limit hole (422).

13. The relay according to claim 12, wherein the movable members further comprise a support part (42) fixedly connected to the lower magnetizer (32) and disposed between the push rod unit (41) and the lower magnetizer (32); the push rod unit (41) fits with the support part (42) through the limit protrusion (413) and the limit hole (422); and the push rod unit (41) is configured to drive the movable contact piece (22) to move.
